(19) United States
(12) Patent Application Publication
(10) Pub. No.: US 2019/0289872 A1
(43) Pub. Date: Sep. 26, 2019

(54) PROTEIN GUMMY COMPOSITIONS

(71) Applicant: Herbaland Naturals Inc., Richmond (CA)

(72) Inventor: Musharaf Syed, Richmond (CA)

(21) Appl. No.: 15/935,802

(22) Filed: Mar. 26, 2018

(51) Int. Cl. A23G 3/42; A23G 3/44; A23G 3/48

(52) U.S. Cl. CPC A23G 3/42; A23V 2002/00; A23G 3/48; A23G 3/44

(57) ABSTRACT

A protein gummy composition comprises between 40% and 80% by weight of a sweetener, between 5% and 30% by weight of a plant-based protein, and between 1% and 10% by weight of a plant-based gelling agent. The sweetener may be at least one sweetener selected from the group of sweeteners including isomalto-oligosaccharide, maltitol, inulin, tapioca syrup, and corn syrup. The plant-based protein may be at least one plant-based protein selected from the group of plant-based proteins including pea protein, rice protein, sunflower protein, hemp protein, and chia protein. The plant-based gelling agent may be at least one plant-based gelling agent selected from the group of plant-based gelling agents including agar, pectin, carrageenan, and locust bean gum.

### TECHNICAL FIELD

The present disclosure relates to protein gummy compositions and, in particular, to organic, vegan protein gummy compositions.

### BACKGROUND

United States Patent Application Publication No. 2010/0226904, which was published on Sep. 9, 2010 in the name of Davis, discloses an organic chewable composition for delivering dietary supplements and pharmaceutical compounds. The chewable composition includes an organic delivery vehicle and an active ingredient. The delivery vehicle may include an organic gummy candy. The active ingredient may include an over-the-counter drug or a prescription drug to provide a desired effect on the user. The active ingredient may also include any combination of nutraceuticals, vitamins, minerals, antioxidants, soluble and insoluble fiber, herbs, plants, amino acids, and digestive enzymes.

### SUMMARY

There is provided a protein gummy composition comprising between 40% and 80% by weight of a sweetener, between 5% and 30% by weight of a plant-based protein, and between 1% and 10% by weight of a plant-based gelling agent. The sweetener may be at least one sweetener selected from the group of sweeteners including isomalto-oligosaccharide, maltitol, inulin, tapioca syrup, and corn syrup. The plant-based protein may be at least one plant-based protein selected from the group of plant-based proteins including pea protein, rice protein, sunflower protein, hemp protein, and chia protein. The plant-based gelling agent may be at least one plant-based gelling agent selected from the group of plant-based gelling agents including agar, pectin, gelatin, carrageenan, and locust bean gum.

The protein gummy composition may further include a liquid solvent. The liquid solvent may be at least one liquid solvent selected from the group of liquid solvents including purified water, concentrated fruit juice, and fruit puree. The protein gummy composition may further include an acid. The acid may be at least one acid selected from the group of acids including citric acid, malic acid, lactic acid, and fumaric acid. The protein gummy composition may further include a buffering agent. The buffering agent may be at least one buffering agent selected from the group of buffering agents including sodium citrate and potassium citrate. The protein gummy composition may further include a natural flavor. The protein gummy composition may further include a natural colorant. The protein gummy composition may further include at least one or more additional sweeteners selected from the group of sweeteners including sucrose, maltose, erythritol, xylitol, inulin powder, monk fruit, and Stevia leaf extract.

There is also provided a protein gummy composition comprising between 40% and 80% by weight of a syrup, between 5% and 30% by weight of a plant-based protein, between 5% and 30% by weight of glycerin, between 1% and 50% by weight of water and between 1% and 10% by weight of a plant-based gelling agent. The protein gummy composition may further include between 1% and 10% by weight of a natural flavor. The protein gummy composition may further include between 0.1% and 5% by weight of an acid. The protein gummy composition may further include up to 1% by weight of a buffering agent.

### DESCRIPTION OF SPECIFIC EMBODIMENTS

Disclosed herein are protein gummy compositions comprised of a sweetener, a plant-based protein, and a plant-based gelling agent. An example of such a protein gummy composition is set out below.

### EXAMPLE 1

| Component | Percent by Weight |
|---|---|
| Sweetener | 40% to 80% |
| Plant-based protein | 5% to 30% |
| Plant-based gelling agent | 1% to 10% |
| Total | 100% |

The sweetener may be provided in a syrup form. The syrup may be, for example, isomalto-oligosaccharide syrup, maltitol syrup, inulin syrup, tapioca syrup, corn syrup, or a combination thereof. The plant-based protein may be, for example, pea protein, rice protein, sunflower protein, hemp protein, chia protein, or a combination thereof. The plant-based protein may be provided in a powder form. The plant-based gelling agent may be, for example, agar, pectin, gelatin, carrageenan, locust bean gum, or a combination thereof.

The protein gummy composition may further include 5.00% to 20.00% by weight of a first additional sweetener and 0.01% to 0.50% by weight of a second additional sweetener. The additional sweeteners may be, for example, sucrose, maltose, erythritol, xylitol, inulin powder, monk fruit, Stevia leaf extract, or a combination thereof. An example of such a protein gummy composition is set out below.

### EXAMPLE 2

| Component | Percent by Weight |
|---|---|
| Syrup | 40.00% to 80.00% |
| Plant-based protein | 5.00% to 30.00% |
| Glycerin | 5.00% to 30.00% |
| Sweetener | 5.00% to 20.00% |
| Liquid solvent | 1.00% to 50.00% |
| Natural flavoring | 1.00% to 10.00% |
| Plant-based gelling agent | 1.00% to 10.00% |
| Acid | 0.10% to 5.00% |
| Buffering agent | 0.00% to 1.00% |
| Other sweetener | 0.01% to 0.50% |
| Total | 100.00% |

The protein gummy composition may further include 5.00% to 30.00% by weight of glycerin. The protein gummy composition may further include 1.00% to 50.00% by weight of a liquid solvent. The liquid solvent may be, for example, purified water, concentrated fruit juice, fruit puree, or a combination thereof. The protein gummy composition may further include 1.00% to 10.00% by weight of natural flavoring. The protein gummy composition may further include 0.10% to 5.00% by weight of an acid. The acid may be citric acid, malic acid, lactic acid, fumaric acid, or a combination thereof. The protein gummy composition may further include 0% to 1.00% by weight of a buffering agent. The buffering agent may be, for example, sodium citrate, potassium citrate or a combination thereof.

An example of a protein gummy composition comprising a sweetener in the form of isomalto-oligosaccharide syrup, a plant-based protein in the form of pea protein, and a plant-based gelling agent in the form of agar is set out below.

### EXAMPLE 3

| Component | Percent by Weight |
|---|---|
| Isomalto-oligosaccharide | 54.78% |
| Pea protein | 18.00% |
| Vegetable glycerin | 10.66% |
| Purified water | 6.15% |
| Erythritol | 3.28% |
| Natural flavoring | 2.46% |
| Citric acid | 1.64% |
| Agar | 1.64% |
| Locust bean gum | 0.82% |
| Potassium citrate | 0.33% |
| Natural colorant | 0.16% |
| Stevia leaf extract | 0.08% |
| Total | 100.00% |

The protein gummy composition may further include organic fruit. An example of such a protein gummy composition is set out below.

### EXAMPLE 4

| Component | Percent by Weight |
|---|---|
| Isomalto-oligosaccharide | 53.74% |
| Pea protein | 18.00% |
| Vegetable glycerin | 10.66% |
| Purified water | 6.15% |
| Erythritol | 3.28% |
| Natural flavoring | 2.46% |
| Citric acid | 1.64% |
| Agar | 1.64% |
| Organic fruit | 1.20% |
| Locust bean gum | 0.82% |
| Potassium citrate | 0.33% |
| Stevia leaf extract | 0.08% |
| Total | 100.00% |

In this example, a natural colorant is not used because the organic fruit provides color to the protein gummy composition. However, in other examples, the protein gummy composition may include both organic fruit and a natural colorant.

It will be understood by a person skilled in the art that many of the details provided above are by way of example only, and are not intended to limit the scope of the invention which is to be determined with reference to the following claims.

1. A protein gummy composition comprising:
between 40% and 80% by weight of a sweetener;
between 5% and 30% by weight of a plant-based protein; and
between 1% and 10% by weight of a plant-based gelling agent, wherein the plant-based gelling agent is agar or pectin.

2. The protein gummy composition as claimed in claim 1, wherein the sweetener is at least one sweetener selected from the group of sweeteners including isomalto-oligosaccharide, maltitol, inulin, tapioca syrup, and corn syrup.

3. The protein gummy composition as claimed in claim 1, wherein the plant-based protein is at least one plant-based protein selected from the group of plant-based proteins including pea protein, rice protein, sunflower protein, hemp protein, and chia protein.

4. (canceled)

5. The protein gummy composition as claimed in claim 1, further including a liquid solvent.

6. The protein gummy composition as claimed in claim 5, wherein the liquid solvent is at least one liquid solvent selected from the group of liquid solvents including purified water, concentrated fruit juice, and fruit puree.

7. The protein gummy composition as claimed in claim 1, further including an acid.

8. The protein gummy composition as claimed in claim 7, wherein the acid is at least one acid selected from the group of acids including citric acid, malic acid, lactic acid, and fumaric acid.

9. The protein gummy composition as claimed in claim 1, further including a buffering agent.

10. The protein gummy composition as claimed in claim 9, wherein the buffering agent is at least one buffering agent selected from the group of buffering agents including sodium citrate and potassium citrate.

11. The protein gummy composition as claimed in claim 1, further including a natural flavor.

12. The protein gummy composition as claimed in claim 1, further including a natural colorant.

13. The protein gummy composition as claimed in claim 1, further including at least one or more additional sweeteners selected from the group of sweeteners including sucrose, maltose, erythritol, xylitol, inulin powder, monk fruit, and Stevia leaf extract.

14. A protein gummy composition comprising:
between 40% and 80% by weight of a syrup;
between 5% and 30% by weight of a plant-based protein;
between 5% and 30% by weight of glycerin;
between 1% and 50% by weight of water; and
between 1% and 10% by weight of a plant-based gelling agent, wherein the plant-based gelling agent is agar or pectin.

15. The protein gummy composition as claimed in claim 14, further including between 1% and 10% by weight of a natural flavor.

16. The protein gummy composition as claimed in claim 14, further including between 0.1% and 5% by weight of an acid.

17. The protein gummy composition as claimed in claim 14, further including up to 1% by weight of a buffering agent.

18. The protein gummy composition as claimed in claim 14, wherein the syrup is at least one syrup selected from the group of syrups including isomalto-oligosaccharide syrup, maltitol syrup, inulin syrup, tapioca syrup, and corn syrup.

19. The protein gummy composition as claimed in claim 14, wherein the plant-based protein is at least one plant-based protein selected from the group of plant-based proteins including pea protein, rice protein, sunflower protein, hemp protein, and chia protein.

20. (canceled)
